(19) United States
(12) Patent Application Publication
(10) Pub. No.: US 2015/0235575 A1
(43) Pub. Date: Aug. 20, 2015

(54) GENERALLY-CYLINDRICAL CONTAINER LABEL PROTECTORS AND APPLICATORS THEREFORE

(71) Applicants: Martin D. Balogh, San Francisco, CA (US); Gregory F. Brown, Northville, MI (US)

(72) Inventors: Martin D. Balogh, San Francisco, CA (US); Gregory F. Brown, Northville, MI (US)

(73) Assignee: Vingarde, LLC, San Francisco, CA (US)

(21) Appl. No.: 14/240,949

(22) PCT Filed: Aug. 24, 2012
(86) PCT No.: PCT/US2012/052223

§ 371 Date: Apr. 15, 2015

Related U.S. Application Data
(60) Provisional application No. 61/527,362, filed on Aug. 25, 2011.

(51) Int. Cl. G09F 3/02; B65D 23/14; G09F 3/00

(52) U.S. Cl. CPC G09F 3/02; G09F 3/0297; B65D 23/14; G09F 2003/023; G09F 2003/0273

(57) ABSTRACT

A label-protected container includes a generally-cylindrical container having a label, a label protector made of a transparent, flexible plastic sheet with a left edge, a right edge, and an inner surface, the label protector positioned over the label but substantially visible through the label protector, and is wrapped around the container so that the left edge and the right edge of the label protector overlap, the inner surface of the label protector has a zone that limits movement of the label protector with respect to the container, and at least a portion of the transparent, flexible plastic sheet in contact with the label is made of a plastic suitable for long term contact with the label, and an adhesive disposed between the overlapping portion of the left edge and the right edge affixing the left edge to the right edge.

### CROSS-REFERENCE TO RELATED APPLICATIONS

This patent application is a National Phase Patent Application of PCT International Application No. PCT/US2012/052223, filed on Aug. 24, 2012, which claims the benefit and priority of U.S. Provisional Patent Application No. 61/527,362, filed on Aug. 25, 2011, each of which is incorporated herein by reference in its entirety.

### BACKGROUND

A wide variety of foodstuffs are kept in bottles with paper labels. Paper labels can show wear such as tears, scuffs, and stains even after routing handling. If a label is damaged before the bottle has been purchased by a customer, the merchant may be forced to lower the price of the product even though the foodstuff inside is undamaged. Even after purchase by a consumer, damage to the label can diminish the value of the bottle to the consumer. This is particularly true for foodstuffs such as wines and spirits which are brought to the table to pour for guests.

Wine labels are also particularly at risk of such damage. Collectable wines must be stored for periods of a few years to multiple decades to allow the wine to mature. During this maturation period, a given bottle of wine can be sold and resold multiple times, which increases the likelihood of the label getting damaged. A typical wine bottle may be bought on release by a wine speculator who will hold the wine bottle for a year or two on the expectation that the price of the wine will increase. The wine speculator will then sell the wine bottle though an auction house or to a wine reseller. The auction house or the wine reseller then sells the wine bottle to a wine collector. Each such transaction often involves shipping the wine bottle which requires packing and unpacking of the wine bottle. All of which can result in wear to the paper label on the wine bottle, thus reducing the resale value and diminishing the enjoyment of the wine by the wine collector who presents the wine bottle to his or her friends at a dinner.

The wine industry has attempted multiple solutions to address this problem, but none have proved to be adequate solutions. Some wine resellers wrap bottles in bubble-wrap, but bubble-wrap obscures the label and is not adequately secured to the bottle for long-term storage. Restaurateurs use cling wrap, but cling wrap can obscure the label due to the difficulty in applying smoothly over the label. Furthermore, many cling wraps are made of polyvinyl chloride-based (PVC) plastics. PVC plastics can degrade over time emitting hydrochloric acid, which can be very damaging to paper labels. Also, neither solution is aesthetically pleasing, so a reseller would be unable to display a wine bottle wrapped in bubble-wrap or cling wrap to potential purchasers. Some have tried using shrink-wrap to seal the bottle entirely in plastic, but shrink-wrap requires heat which can damage the wine and/or the label. Thus, the wine industry has been working on solving the problem and has various short-term attempted solutions, but has yet to solve the problem and find a viable solution in a manner suitable for long term storage.

Various other systems for covering labels have been developed, but none meet this need since they were developed for other purposes. For example, U.S. Pub. No. 2005/0229450 discloses a decorative system for wrapping containers. The system in certain embodiments includes a removable panel that reveals a transparent panel through which the label on the container can be seen. However, no where in U.S. Pub. No. 2005/0229450 is there any disclosure that the transparent panel must be made of a plastic that can remain in contact with the label for a long period of time without discoloring or otherwise damaging the label (i.e., a plastic suitable for long term contact with paper).

Thus, there is a need for a label protector that can readily be applied to a bottle by consumers and merchants alike to protect the labels (e.g., paper labels) on the bottle. The labels need to be protected over a long period of time to ensure that the price of the bottle is not diminished. Also, the labels must be visible through the label protector.

### SUMMARY

The inventions disclosed herein solve the long-felt need by providing label protectors, an applicator base, and methods of making and using them.

In an embodiment, a label-protected, generally-cylindrical container is disclosed. The label-protected, generally-cylindrical container includes a generally-cylindrical container having a label, a label protector made of a transparent, flexible plastic sheet and having a left edge, a right edge, and an inner surface, the label protector positioned over the label such that the label is protected from wear but substantially visible through the label protector, and is wrapped around the generally-cylindrical container so that the left edge and the right edge of the label protector overlap, the inner surface of the label protector has a zone that limits movement of the label protector with respect to the generally-cylindrical container, and at least a portion of the transparent, flexible plastic sheet in contact with the label is made of a plastic suitable for long term contact with the label, and an adhesive disposed between the overlapping portion of the left edge and the right edge affixing the left edge to the right edge.

### BRIEF DESCRIPTION OF THE DRAWINGS

FIG. 1 shows an embodiment of a label protector applied to protect the label of a wine bottle.

FIG. 2 shows the embodiment of the label protector shown in FIG. 1 prior to application to a wine bottle.

FIG. 3 shows a perspective view of the label protector embodiment shown in FIG. 2.

FIG. 4 shows another form of the embodiment of FIGS. 1-3 of the label protector prior to application to a generally-cylindrical container.

FIG. 5 shows the embodiment of the label protector shown in FIG. 4 applied to protect the label of a wine bottle.

FIG. 6 shows a side view of the embodiment of the label protector shown in FIG. 4 applied to protect the label of a wine bottle.

FIG. 7 shows a perspective view of a removable backing sized to cover the embodiment of the label protectors of FIGS. 4-6.

FIG. 8 shows a perspective view of the embodiment of the label protectors of FIGS. 4-6.

FIG. 9 shows the embodiment of the label protector shown in FIG. 4 applied to protect the label of a wine bottle.

FIG. 10 shows a second embodiment of a label protector.

FIG. 11 shows the embodiment of the label protector applied to protect the label of a wine bottle.

FIG. 12 shows a perspective view of the embodiment of the label protector of FIGS. 10-11.

FIG. 13 shows a perspective view of a removable backing sized to cover the embodiment of the label protector of FIGS. 10-11.

FIG. 14 shows a third embodiment of a label protector.

FIG. 15 shows the embodiment of the label protector shown in FIG. 14 applied to protect the label of a wine bottle.

FIG. 16 shows a bottom side view of an embodiment of a label applicator.

FIG. 17 shows a top view of an embodiment of the label applicator.

FIG. 18 shows a left side view of an embodiment of the label applicator.

FIG. 19 shows a perspective view of an embodiment of the label applicator.

FIG. 20 shows a fourth embodiment of a label protector.

### DETAILED DESCRIPTION

This disclosure provides multiple embodiments describing label protectors that can be affixed to cover the labels of generally-cylindrical containers to protect the labels from damage such as scuffing, tearing, scraping, mold, staining, fading, etc. To prevent the label protector itself from harming the label (e.g., a paper label), a portion of the label in contact with the label is made out of a plastic material suitable for long term contact with the label (e.g., paper). The label protectors described herein leave the paper label substantially visible. This allows the label to be read and viewed through the label protector without needing to remove the label protector.

Some implementations of the label protectors require careful alignment when being placed upon the generally cylindrical container. To assist with the alignment, this disclosure also provides label applicators that include guides that position the generally-cylindrical container and the label protector relative to one another so that the label protector will be aligned correctly when affixed to the generally-cylindrical container.

Label Protectors

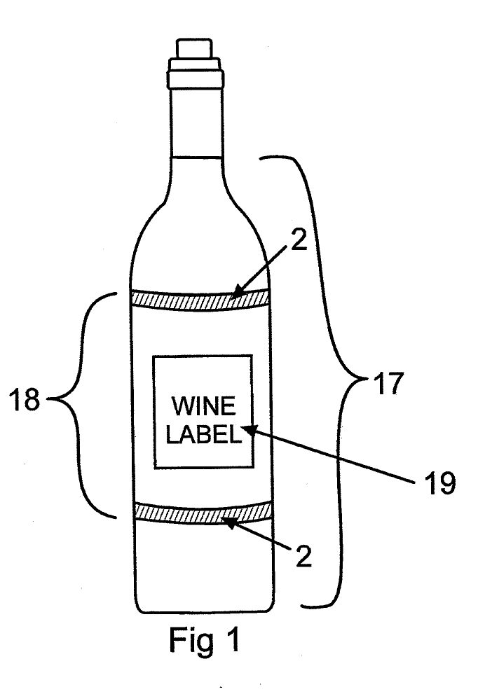

FIG. 1 shows a first embodiment of a label protector 18 applied or positioned to protect the label 19 (e.g., a paper label) of a wine bottle 17 as an exemplary generally-cylindrical container. The label protector 18 in FIG. 1 is made from a transparent, flexible plastic sheet. The transparent, flexible plastic sheet is wrapped around the wine bottle 17 so that a left edge and a right edge of the label protector 18 overlap. An adhesive is disposed between the overlapping portions to affix the left edge to the right edge. This holds the label protector 18 around the wine bottle 17 without the adhesive contacting the wine bottle 17 and/or the label 19. In an embodiment, the label protector 18 can still move up and down and rotationally around the wine bottle 17. To prevent such movement of the label protector 18, an inner surface of the label protector 18 has a zone (e.g., top and/or bottom fastening or gripping strips) that limits movement of the label protector 18 against the wine bottle 17. In an embodiment, this zone on the label protector 18 in FIG. 1 is formed by a first top static cling strip 2 disposed along a top edge of the label protector 18 and/or a second bottom static cling strip 2 disposed along a bottom edge of the label protector 18. The first and second static cling strips 2 limit movement of the label protector 18 against the wine bottle 17. This particular implementation of the first embodiment is particularly preferred as no adhesive is in contact with the wine bottle 17 or the label 19.

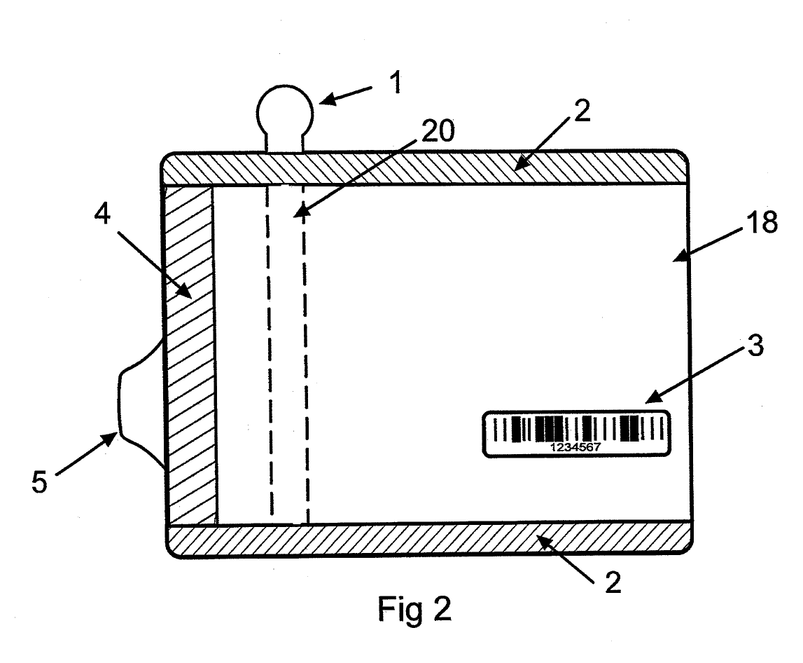

FIG. 2 shows an inside or inner view of the label protector 18 in FIG. 1. The label protector 18 is shown prior to application to a generally-cylindrical container. The label protector 18 includes an adhesive 4 along the left edge which when the label protector 18 is wrapped around the container will overlap with the right edge thereby affixing the left edge to the right edge. The label protector 18 includes a tab 5 extending from the left edge that allows removal of the label protector 18 from a generally-cylindrical container. In one embodiment, the tab 5 is part of the flexible, plastic sheet that forms the label protector 18. In other embodiments, the tab 5 can be a separate piece affixed directly or indirectly to the left or right edge of the flexible, plastic sheet. The static cling strips 2 may be visible on the label protector 18 and disposed along the top and bottom inner edges, which limits movement of the label protector 18 when wrapped around a generally-cylindrical container. The label protector 18 further includes a tab 1 that is proximal to a perforated zone 20 which extends substantially across (in a vertical direction or a horizontal direction) the entire label protector 18. Pulling on the tab 1 in a downward direction tears the label protector 18 along the perforated zone 20 allowing the label protector 18 to be removed from the generally-cylindrical container. In general, the tab 1 and the tab 5 are alternative embodiments as they both provide a means for removal of the label protector 18. Finally, the label protector 18 includes an optional machine-readable identifier 3. The machine-readable identifier 3 may be a standard bar code, a 2-D bar code or a Radio-Frequency Identification (RFID) tag.

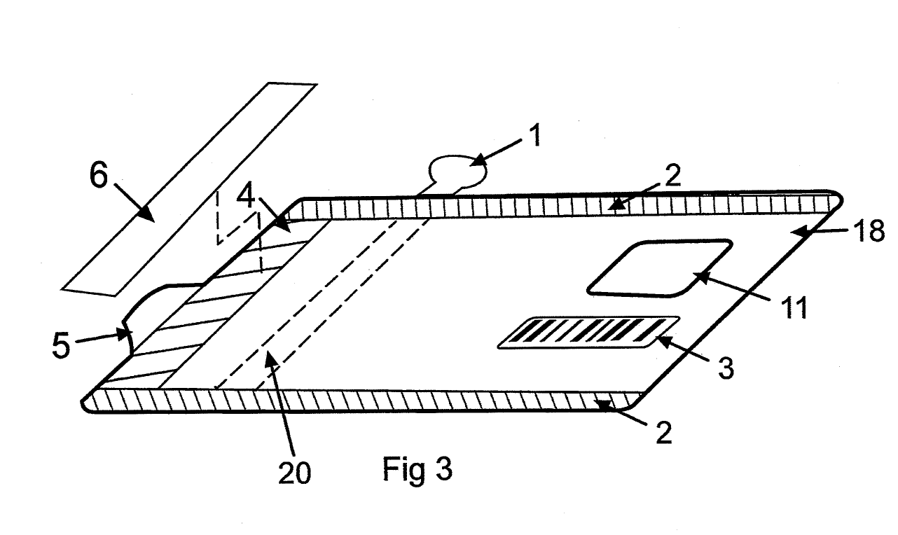

FIG. 3 shows a perspective view of the label protector 18 embodiment shown in FIGS. 1 and 2. The label protector 18 is shown with a removable backing 6 positioned over the adhesive 4. The removable backing 6 prevents the adhesive 4 from adhering before the label protector 18 is ready for use. The label protector 18 further shows an optional opaque portion 11 on the outer surface for writing. The opaque portion 11 is disposed on the label protector 18 to avoid blocking the paper label 19 from being viewed or shown when the label protector 18 is positioned over the label 19 and is affixed to the generally-cylindrical container.

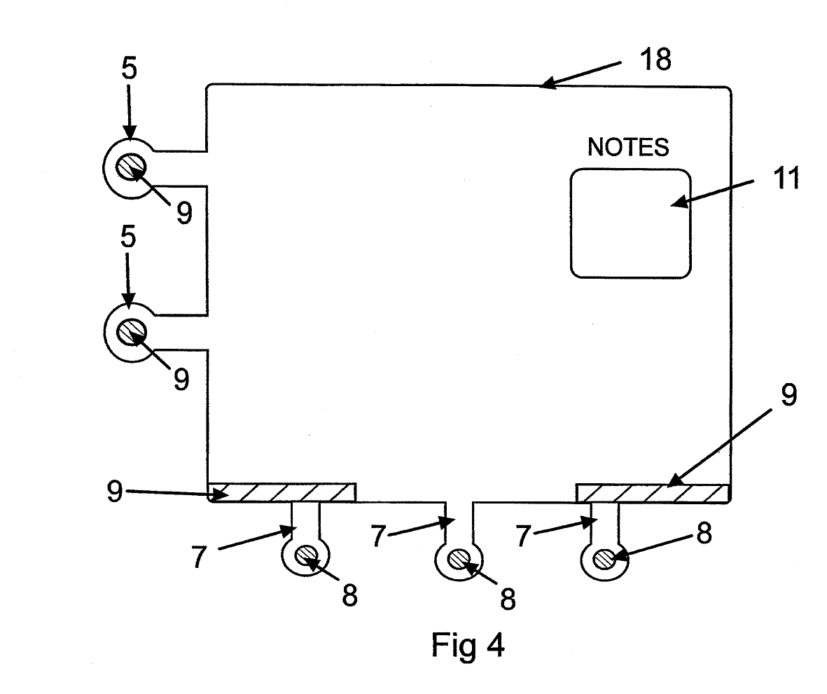

FIG. 4 shows another form of the first embodiment of the label protector 18 prior to application to a generally-cylindrical container. The label protector 18 includes an adhesive 9 disposed on the tabs 5 along the left edge. The tabs 5 are formed in the shape of a circle and extend outward from one or more sides, the top, and/or the bottom. The adhesive 9 on the tab 5 overlap with the right edge of the label protector 18 when it is wrapped around the container thereby affixing the left edge to the right edge. The tabs 5 also allow removal of the label protector 18 from a generally-cylindrical container. The label protector 18 includes an adhesive 9 along the bottom edge that acts as the zone that limits movement of the label protector 18 against the wine bottle 17. Since the adhesive 9 along the bottom edge contacts the wine bottle 17, the adhesive 9 does not extend along the entire bottom edge. Rather the adhesive 9 is not applied to the middle portion which potentially will overlap the paper label 19. The label protector 18 further includes flexible plastic tabs 7 disposed along the bottom edge. The flexible plastic tabs 7 fold under the bottom of the generally-cylindrical container and adhere to the bottom of the container via or through the adhesive 8. The flexible plastic tabs 7 together with the adhesive 8 further prevent the generally-cylindrical container from slipping out of the label protector 18, when the generally-cylindrical container is held by grasping the label protector 18. Finally, the label protector 18 includes an optional opaque surface 11 for writing notes on. The optional opaque surface 11 is positioned so as to not obscure the label when the label protector 18 is wrapped around a generally-cylindrical container.

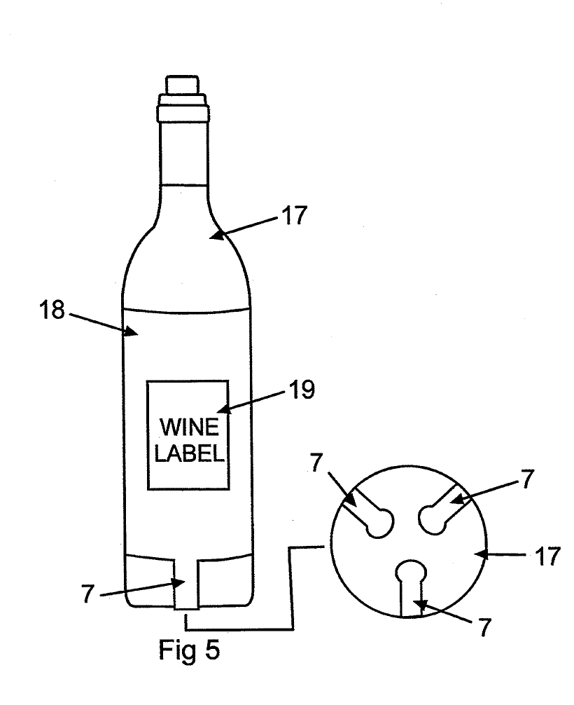

FIG. 5 shows the embodiment of the label protector 18 shown in FIG. 4 applied to protect the label 19 of the wine bottle 17 as an exemplary generally-cylindrical container. The flexible plastic tabs 7 are shown folded under and affixed to the bottom of the wine bottle via or through the adhesive 8. Even though 3 tabs 7 are shown, 1, 2, 4, 5 or 6 tabs 7 can be used depending on the size of the generally-cylindrical container.

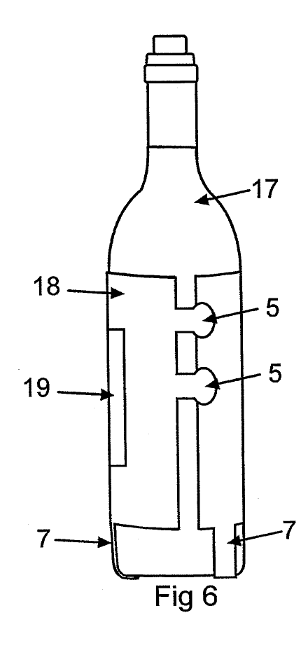

FIG. 6 shows a side view of the embodiment of the label protector 18 shown in FIG. 4 applied to protect the label 19 of the wine bottle 17 as an exemplary generally-cylindrical container. The side view shows the tabs 5 affixed to the right edge of the label protectors 18 through the adhesive 9. Even though 2 tabs 5 are shown, 1, 3, 4, 5 or 6 tabs 5 can be used depending on the size of the generally-cylindrical container.

FIG. 7 shows a perspective view of a removable backing 10 sized to cover the label protector 18 of FIGS. 4-6. The removable backing 10 helps keep the inner or inside surface of the label protector 18 clean and damage-free.

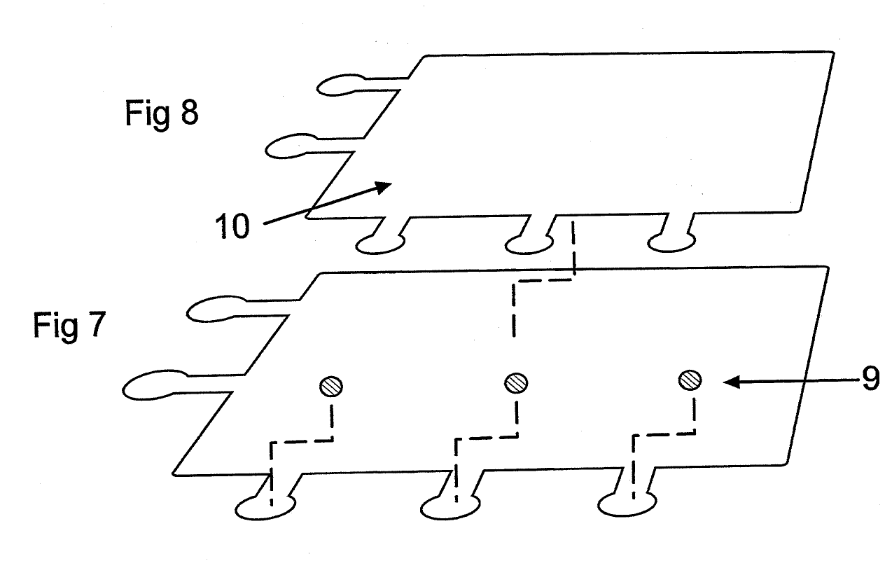

FIG. 8 shows a perspective view of the label protector 18 of FIGS. 4-6 with separate removable backing 10 that covers and protects the adhesive 9 until removed from the label protector 18.

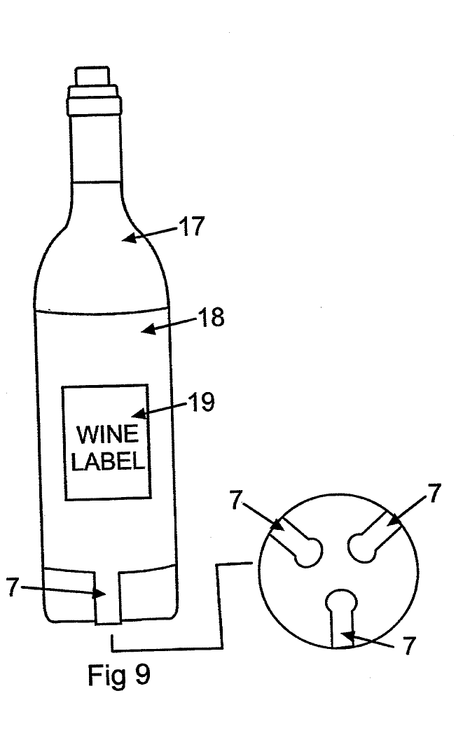

FIG. 9 shows the embodiment of the label protector 18 shown in FIG. 4 applied to protect the label 19 of the wine bottle 17.

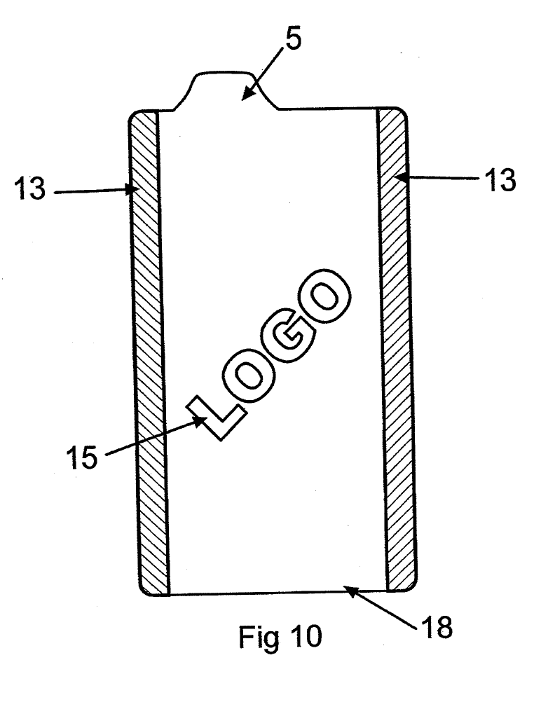

FIG. 10 shows a second embodiment of the label protector 18. The label protector 18 in the second embodiment only partially wraps around the generally-cylindrical container, so the label protector 18 relies upon an alternative device or means for affixing the label protector 18 to the generally-cylindrical container. The label protector 18 has an adhesive or adherent zone disposed on the inner surface of the label protector 18 to substantially avoid contacting the paper label 19. Instead, the adhesive or adherent zone adheres to the generally-cylindrical container directly. In FIG. 10, the adhesive or adherent zone is formed by two adhesive strips 13 disposed along the left and right edges or sides of the label protector 18. The label protector 18 includes a tab 5 that allows for easy removal of the label protector 18 from a generally-cylindrical container. The label protector 18 also includes an optional semi-opaque logo 15. In this embodiment, the semi-opaque logo 15 is positioned over the paper label 19 when the label protector 18 is affixed to a generally-cylindrical container, but the paper label 19 is still substantially visible so the paper label 19 can be read.

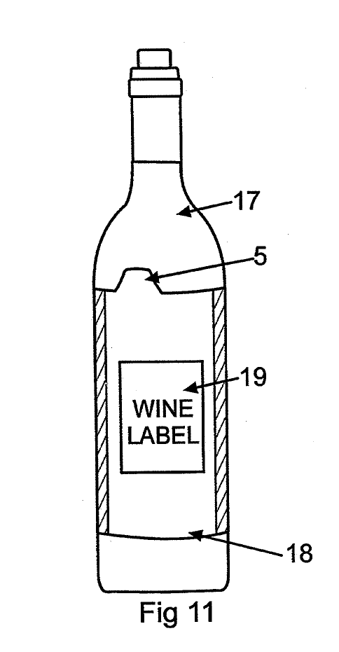

FIG. 11 shows the second embodiment of the label protector 18 shown in FIG. 10 applied to protect the label 19 of the wine bottle 17 as an exemplary generally-cylindrical container. The label protector 18 is positioned so that it is affixed to the wine bottle 17 through or via the adhesive strips 13. As shown, the adhesive strips 13 are disposed so as to adhere to the wine bottle 17 without adhering to the label 19 to avoid damaging the label 19 when removing the label protector 18. Hence, the label protector 18 is sized to be larger than the label 19 on all sides that include an adhesive strip 13 by at least a width on the adhesive strip 13.

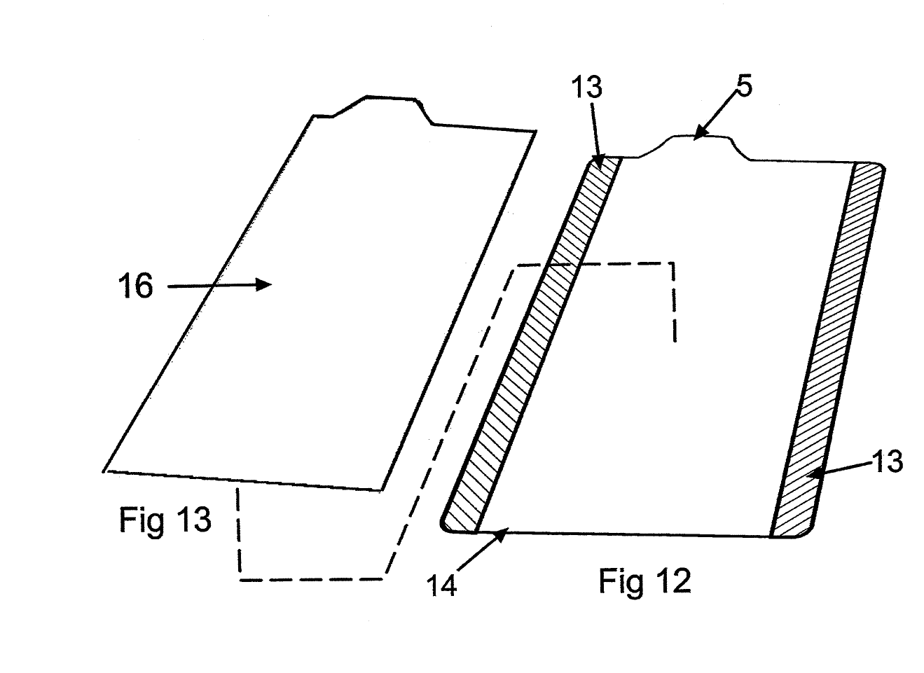

FIG. 12 shows a perspective view of the second embodiment of the label protector 18 of FIGS. 10-11.

FIG. 13 shows a perspective view of a removable backing 16 sized to cover the label protector 18 of FIGS. 10-11. The removable backing 16 helps keep the inner or inside surface of the label protector 18 clean and damage-free.

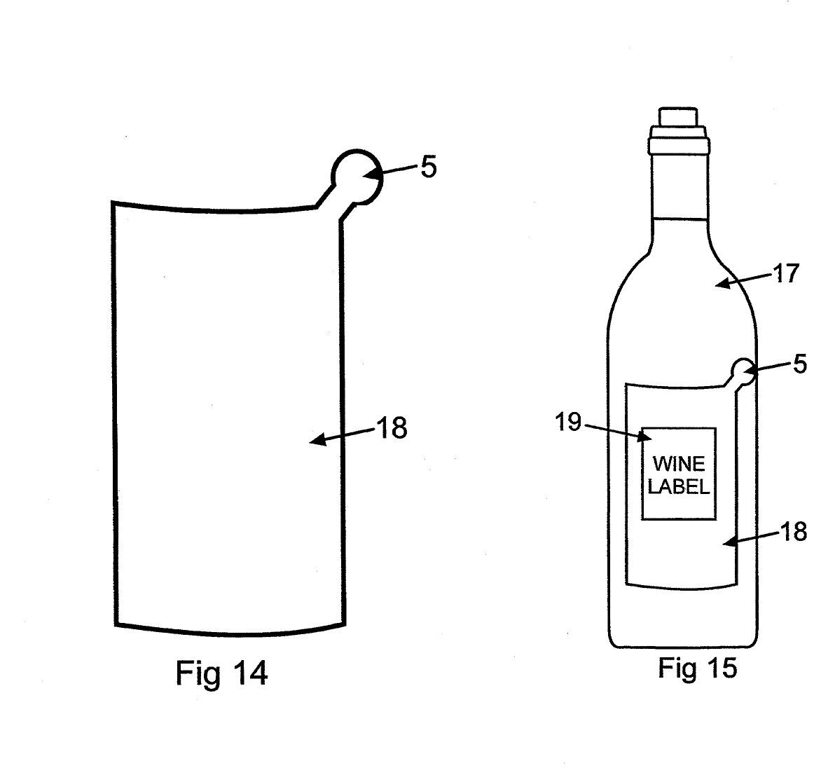

FIG. 14 shows a third embodiment of the label protector 18. In the third embodiment, the label protector 18 has an adhesive or adherent zone disposed along the inner surface that has a low enough peel strength that the paper label won't tear when the label protector 18 is removed. In an exemplary embodiment, the adherent zone is a static cling inner surface. The label protector 18 includes a tab 5 that allows removal of the label protector 18 from a generally-cylindrical container.

FIG. 15 shows the embodiment of the label protector 18 shown in FIG. 14 applied to protect the label 19 of the wine bottle 17 as an exemplary generally-cylindrical container. The label protector 18 can be affixed to the wine bottle 17 through the static cling inner surface.

FIG. 20 shows an inside or inner view of a fourth embodiment of the label protector 18. The label protector 18 is shown prior to application to a generally-cylindrical container. The label protector 18 includes an adhesive 4 along the left edge which when the label protector 18 is wrapped around the container will overlap with the right edge thereby affixing the left edge to the right edge. The label protector 18 includes a tab 5 extending from the left edge that allows removal of the label protector 18 from a generally-cylindrical container. In one embodiment, the tab 5 is part of the flexible, plastic sheet that forms the label protector 18. In other embodiments, the tab 5 can be a separate piece affixed directly or indirectly to the left or right edge of the flexible, plastic sheet. The inner surface of the label protector 18 is adherent except for deadener surface 41 to which a transparent, non-adherent material that is suitable for long term contact with the label has been applied. The adherent inner surface that is exposed after the deadener is applied limits movement of the label protector 18 when wrapped around a generally-cylindrical container. The label protector 18 further includes a tab 1 that is proximal to a perforated zone 20 which extends substantially across (in a vertical direction or a horizontal direction) the entire label protector 18. Pulling on the tab 1 in a downward direction tears the label protector 18 along the perforated zone 20 allowing the label protector 18 to be removed from the generally-cylindrical container. In general, the tab 1 and the tab 5 can be alternative embodiments as they both provide a means for removal of the label protector 18.

Label Applicators

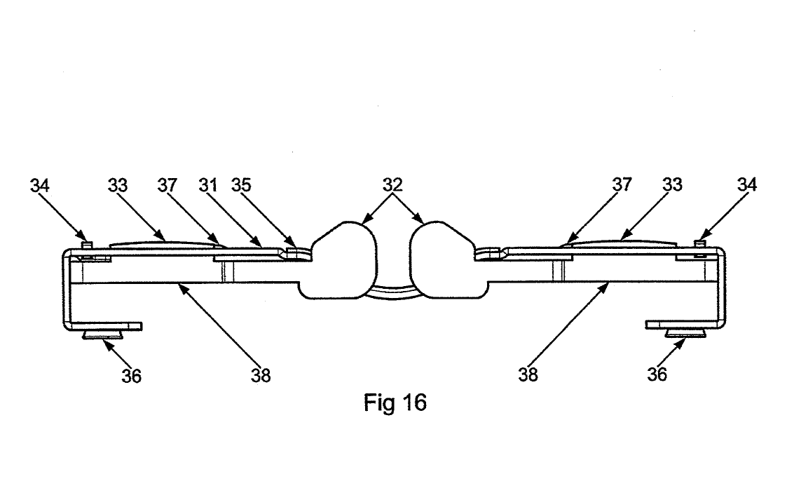

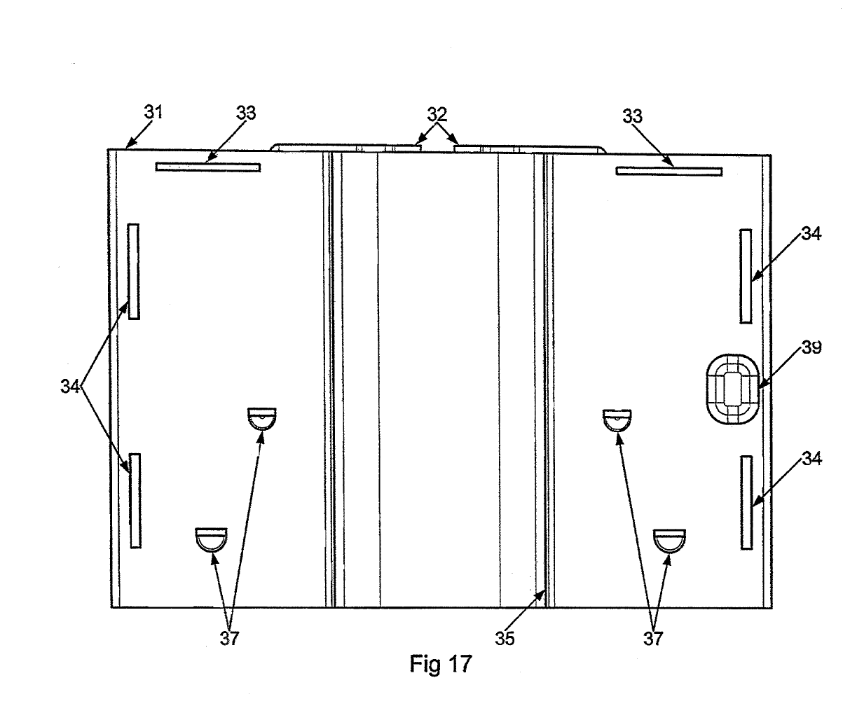

FIG. 16 shows a bottom side view of an embodiment of a label applicator 31 with two metal guide pieces 38 which form the wine bottle alignment guides 32, label protector bottom alignment guides 33 and side alignment guides 34. This embodiment uses two label protector side alignment guides 34 on each side with a gap between them to allow an optional tab 5 of the label protector to lie in the gap. The optional label protector top alignment guides 37 are visible behind the label protector bottom alignment guides 33. This embodiment includes label protector top alignment guides for two different sizes of label protectors. A slot liner 35 is shown lining the bottle slot. The slot liner 35 can act as a cushion to protect the generally-cylindrical container and/or the paper label. The slot liner 35 can also limit movement of the generally-cylindrical container and/or the label protector 18 once placed on the label applicator 31. Two optional applicator feet 36 are also shown. The one label protector alignment guides and the generally-cylindrical container alignment guide are positioned so that the label protector 18 will be correctly aligned when affixed to the generally-cylindrical container. A preferred embodiment is for the alignment guide and the generally-cylindrical container slot to be arranged so that the generally-cylindrical container is placed into the slot with the paper label 19 facing down. This embodiment makes it easy for the end-user to ensure that the label 19 will be positioned relative to the label protector 18 so that the label 19 will be substantially visible through the label protector 18.

FIG. 17 shows a top view of an embodiment of the label applicator 31 with the wine bottle alignment guides 32, the label protector bottom alignment guides 33 and the side alignment guides 34. The optional label protector alignment guides 37 for two sizes of label protector are shown. An optional label protector divot 39 is shown. The label protector divot 39 allows the end user to easily lift an edge of the label protector 18 to warp it around the generally-cylindrical container. This embodiment only has a divot on one side as the label protector and has an optional tab 5 on the other side that lies between the gap in the label protector side alignment guides 34. The optional tab 5 projects over the edge of the substantially planar surface of the label applicator 31, so the end-user can readily lift the other side of the label protector 18 with the tab 5. For embodiments of the label protector 18 without a tab 5, the label applicator 31 may have the label protector divot 39 on the left and right edges or sides of the label applicator 31.

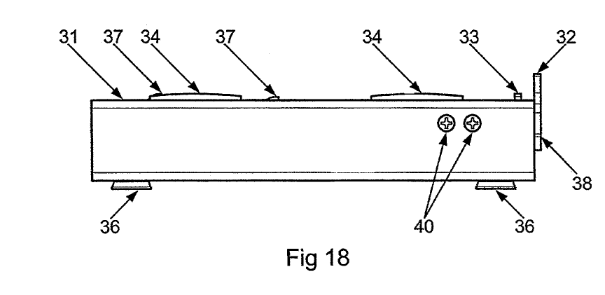

FIG. 18 shows a left side view of an embodiment of the label applicator 31 with one visible metal guide piece 38 which forms the wine bottle alignment guide 32, the label protector bottom alignment guide 33 and the side alignment guides 34. Devices and means for securing the metal guide piece 40 to the label applicator 31 are shown. The optional label protector alignment guides 37 for two sizes of the label protectors are visible behind the label protector side alignment guides 34. Two optional applicator feet 36 are also shown.

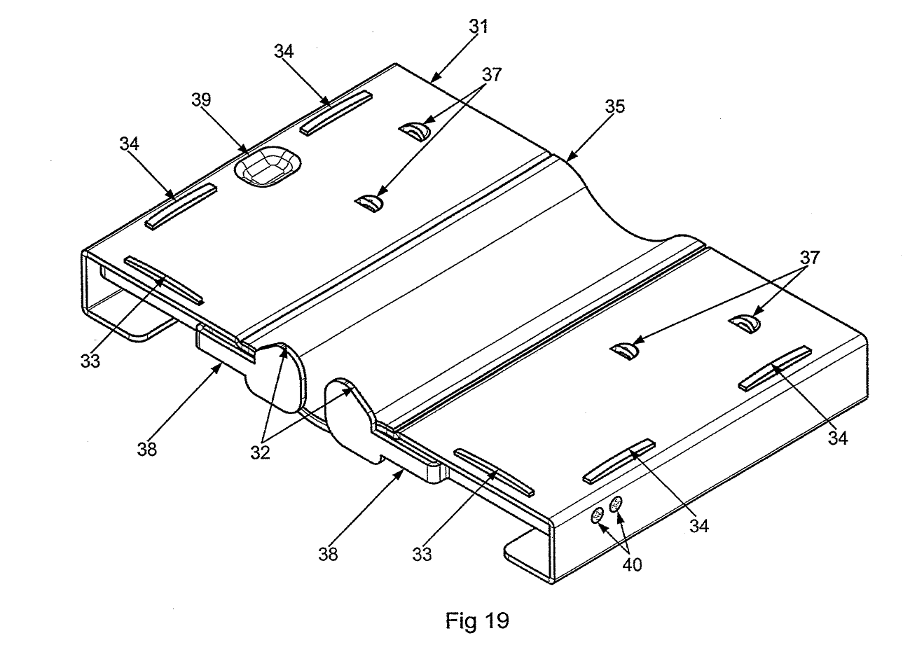

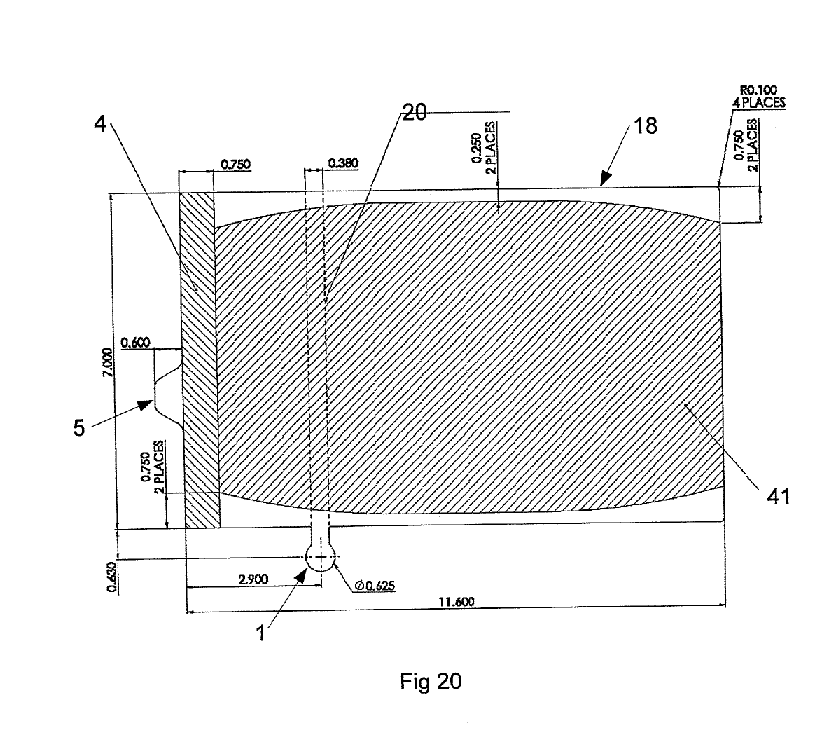

FIG. 19 shows a perspective view of an embodiment of the label applicator 31 with two metal guide pieces 38 which form the wine bottle alignment guides 32, the label protector bottom alignment guides 33 and the side alignment guides 34. Devices and means for securing the metal guide piece 40 to the label applicator 31 are shown. A slot liner 35 is shown lining the bottle slot. The optional label protector alignment guides 37 for two sizes of label protectors are shown. An optional label protector divot 39 is shown.

Transparent, Flexible Plastic Sheet

In various embodiments of the label protectors disclosed herein, the label protectors include a transparent, flexible plastic sheet that covers the paper label of the generally-cylindrical container. The portion of transparent, flexible plastic sheet in contact with the paper label is one suitable for long-term contact with the paper label. The plastics are preferably uncoated (i.e., no adhesive or adherent) on the inner surface where it is in contact with the paper label, though in one or more embodiments, the plastic film may be coated with an adhesive or adherent to form an adherent or adhesive zone with a low enough peel strength that it won't tear paper labels when removed or the plastic film has an adherent or adhesive inner surface over which a deadener has been applied at least to the portion in contact with the paper label. In certain embodiments, the transparent, flexible plastic sheet is, or is coated on the inner surface with, polyester, polypropylene, and polyethylene. These three types of plastic are preferred as they are suitable for long term protection of paper labels. An uncoated polyester film, such as the one sold using the trademark MELINEX®, is suitable for use in the label-protectors due to its stability. Polyester comes in rolls or pre-cut sheets. Polyethylene is highly flexible but not as clear, so it is not as preferred as polyester. Polyvinyl chloride (PVC) enclosures, sometimes referred to as vinyl, are not acceptable for use, because they are very unstable. The transparent, flexible plastic sheet typically has a thickness of between about 1 to 10 mils or between about 3 and 6 mils or about 4 mils.

Deadener

Where a plastic film is used that has an adherent inner surface or has an adhesive applied, a deadener may be applied so that the adherent or adhesive surface is substantially not (or not at all) in contact with the label. The deadener is translucent or preferably transparent to allow the label to be readable through the plastic film. In addition, the deadener is preferably made of a material that is suitable for long term contact with paper labels. The deadener is typically applied on top of the adherent or adhesive surface to create a “dead zone” in the middle of the label where there is no adhesive or tackiness, leaving the perimeter of the adherent or adhesive surface of the label protector exposed so the label protector can be affixed to the container and limit movement relative to the generally-cylindrical container. Preferred deadener materials are polyester or a cellulose acetate varnishes, preferably free of any silicone as well, so the deadener will not react, discolor, or otherwise negatively affect the paper label of the container.

Generally-Cylindrical Containers

The label protectors disclosed herein may be used to protect any generally-cylindrical container with a paper label that is susceptible to damage. Examples of the generally-cylindrical containers may include wine bottles, whiskey bottles, Port bottles, Madeira bottles, and olive oil bottles. Other shapes of containers such as rectangular or oval can also be used.

Wine Bottles

Wine bottles are a preferred embodiment of generally-cylindrical containers as many wines require long-term storage to allow the wines to mature. In addition, such collectable wines are often sold and re-sold which can subject the paper label to substantial wear.

Sizes

Wine bottles come in a wide variety of sizes. The label protectors and label applicators disclosed herein can be adapted to be used with any size of wine bottle. Table 1 below provides the standard sizes presently in use.

TABLE 1

| | | Volume | |
|---|---|---|---|
| Volume (liters) | Name(s) | (liters) | Name(s) |
| 0.1875 | Piccolo/Split | 9.0 | Mordechai/Salmanazar |
| 0.25 | Chopine | 12.0 | Balthazar |
| 0.375 | Demi/Half | 15.0 | Nebuchadnezzar |
| 0.5 | Jennie | 18.0 | Melchior |
| 0.75 | Standard | 20.0 | Solomon |
| 1.5 | Magnum | 25.0 | Sovereign |
| 3.0 | Jeroboam/Double | 27.0 | Primat |
| | Magnum | | |
| 4.5 | Rehoboam | 30.0 | Melchizedek |
| 6.0 | Imperial/Methuselah | | |

The above sizes are for illustrative purposes only. The label protectors can be adapted to any size generally-cylindrical container. Further, one of skill in the art would recognize that the name for the sizes of wine bottles vary from region to regions, e.g., the Jeroboam in Bordeaux is 4.5 liters. Therefore, for the sake of clarity, any reference to a bottle size name used herein will refer to the volume on Table 1 above.

Shapes

Wine bottles come in a wide variety of shapes as well. The label protectors and label applicators disclose herein can be adapted to be used with any shape of wine bottle such as when the wine bottle is generally-cylindrical. Minor irregularities such as raised text or an embossed insignia or symbol will not prevent affixing the label protectors to a generally-cylindrical container.

Wine producers in Portugal, Italy, Spain, France and Germany follow the tradition of their local areas in choosing the shape of bottle most appropriate for their wine.

Port, sherry, and Bordeaux varieties: straight-sided and high-shouldered with a pronounced punt. Port and sherry bottles may have a bulbous neck to collect any residue.

Burgundies and Rhone varieties: tall bottles with sloping shoulders and a smaller punt.

Rhine (also known as hock or hoch), Mosel, and Alsace varieties: narrow and tall with little or no punt.

Champagne and other sparkling wines: thick-walled and wide with a pronounced punt and sloping shoulders.

German wines from Franconia: the Bocksbeutel bottle.

The Chianti and some other Italian wines: the fiasco, a round-bottomed flask encased in a straw basket.

Exemplary Label Protectors

In an embodiment, label protectors were made for a standard Burgundy wine bottle and a standard Bordeaux wine bottle. The label protectors were made using about 5 mils Transilwrap clear print oriented polyester plastic sheets cut to 11.6″×6.75″ (Bordeaux) or 4.5″ (Burgundy). The plastic sheets included a plastic tab 2.355″ from the bottom edge that was 1.58″ wide and extended 0.6″ out from the sheet. A 0.5″ strip of 3M Repositionable Tape (Part Number: 9425) was applied from the top edge to the bottom edge along the edge of the plastic sheet with the plastic sheet, excluding the zone where the vinyl strips were applied as described below. See arrangement of 4, 5 and 2 in the label protector of FIG. 2. The 3M Repositionable Tape includes removable backing (a “release liner” in the 3M product literature). Two 0.25″ wide strips of 0.7 mil vinyl static cling strips from RitRAMA were applied along the top and bottom edges or sides of the plastic sheet.

In another embodiment, label protectors were made for a standard Burgundy wine bottle and a standard Bordeaux wine bottle. The label protectors were made using about 2 mils RitRAMA™ Clear Cling (number 4-0260). The plastic sheets were cut as shown in FIG. 20. A permanent adhesive strip 0.75″ wide was applied to the inner surface from the top edge to the bottom edge along the edge of the plastic sheet. A polyester deadener varnish was applied in the pattern shown on FIG. 20.

Adhesives and Adherent Material

Various embodiments of the label protectors include adhesive and/or adherent zones that serve specific purposes. One of ordinary skill in the art can readily select the appropriate adhesive or adherent material that will serve the specific purpose. Preferred adhesives are pressure sensitive adhesives (PSAs). Pressure sensitive adhesives, also known as a self-adhesive or self-stick adhesive, form a bond between the adhesive and substrate when adequate pressure is applied. PSAs form a bond without the use of solvents, moisture, heat, UV light, etc. and are commonly used in a variety of tapes, note pads, and stamps.

Pressure sensitive adhesives are formulated with a proper balance between flow and resistance to flow. A bond between a PSA and a substrate is formed when the adhesive is soft enough to flow into the microscopic surface imperfections of the substrate. However, the PSA needs to be strong enough to resist flow when force is applied to the bond between the adhesive and substrate. The bond between adhesive and substrate is also strengthened by molecular interactions, such as van der Waals forces (the sum of the attractive or repulsive forces between molecules).

One valuable characteristic of PSAs is their ability to resist shear forces (forces parallel to the substrate and adhesive) more than normal forces (forces perpendicular to the substrate and adhesive). This unique characteristic of PSAs can be useful depending upon the purpose of the adhesive in the particular embodiment of the label protector. For example, in embodiments where the PSA is used to affix the label protector to a generally-cylindrical container, a shear force will be applied between the label protector and the container when a user holds the bottle by gripping the label protector. Because the PSA selected will have a sufficiently strong bond under shear stress based upon the weight of the container and the surface area of the adhesive zone, the container will not slip out of the user's hand and crash onto the floor. However, when the time comes to unwrap such embodiments of the label protector from a container (e.g., when a customer wants to enjoy a bottle of wine), it is relatively easy to unwrap the label protector because the PSA selected will have relatively weak peel strength (peeling the label protector creates a force perpendicular to the surface of the cylindrical bottle).

PSAs are typically created using an elastomer combined with a suitable tackifier (chemical compounds that increase the tackiness of an adhesive). The elastomers can be made from acrylics, butyl rubber, Ethylene-vinyl acetate (EVA), natural rubber, nitriles, silicone rubbers, Styrene block copolymers (SBC), and vinyl ethers. Tackifiers can be made with resins (e.g., aliphatic, cycloaliphatic and aromatic resins (C5 aliphatic resins, C9 aromatic resins, and mixtures thereof), hydrogenated hydrocarbon resins, and their mixtures, terpene-phenol resins (TPR, used often with ethylene-vinyl acetate adhesives), rosins and their derivates, and terpenes and modified terpenes).

Pressure sensitive adhesives can be formulated to be either permanent or removable. Removable adhesives form a temporary bond that can be removed years after application without leaving any adhesive residue behind.

There are two main categories of adhesives used in certain embodiments of the label protectors. The first category is for use in affixing the label protector to itself (e.g., where the label protector wraps completely around the generally-cylindrical container and overlaps itself). This category of adhesive can be a permanent PSA because the label protector does not need to be pulled apart. The label protector in such embodiments will preferably be removed with a perforated tear strip.

The second category of adhesive is for use in affixing the label protector directly to the generally-cylindrical container (though substantially avoiding contact with the paper label). This category of adhesive is preferably a removable PSA. Also, removable PSAs preferably will not leave any residue on the generally-cylindrical container when removed, even when the label protector has been affixed to the container for six months, for one year, or for two years or more. The removable PSA in such embodiments needs to be strong enough to resist the typical shear stresses (e.g., a user handling the generally-cylindrical container by gripping the label protector), yet weak enough to be easily removed by pulling on a pull tab (normal force). 3M Repositionable Tape (Part Number: 9425) with an adhesion to steel on the backside (the removable side) of 12 oz./in. is a preferred example of such a removable PSA.

In certain embodiments, this second category of adhesive or adherent surface is provided the plastic sheet. In these embodiments, the inner surface of the plastic sheet has been treated so as to be adherent or an adhesive has been applied. An example of such plastic sheet is RITRAMA®'s clear polyester film print treated for use with UV and conventional inks designed with a unique polymer technology that allows the film to cling to glass and other smooth substrates (Product Code: 4-0260, 2 mils). The plastic sheet may also have a deadener applied to the adherent or adhesive surface as described above in the “Deadener” Section.

Adherent materials used in certain embodiments of the label protectors adhere through a cohesive bond, so named because of the cohesive forces between smooth surfaces. An example of an adherent material is a so-called vinyl static cling material. When thin vinyl film is softened (with plasticizers) and highly polished, the pliable vinyl is so smooth it acts like a flat suction cup. The same effect can be witnessed when stacking several sheets of smooth glass on top of one another; the glass pieces will stick together. This is a cohesive force and is how products such as RitRAMA 3-1321 (7.0-mil Static Cling gloss clear flexible vinyl) adhere to glass or polished surfaces.

This cohesive phenomenon is preferred for many embodiments of the label protectors because it adheres to glass (smooth surface), but not to paper labels (generally a rough surface) and therefore may not require an adhesive to affix the label protector or limit movement relative to the generally-cylindrical container. In certain embodiments, this type of adherent plastic can be used as the transparent, flexible plastic sheet of the label protector. In other embodiments of a “hybrid” label protector, the adherent material can be used as thin strips at the top and/or bottom of the label protector to create an adherent zone that limits movement of the label protector against the generally-cylindrical container (i.e., the adherent zone has a sufficient shear strength prevent the label protector from slipping). Such embodiments of “hybrid” label protectors would preferably have a polyester film as the transparent, flexible plastic sheet (for its aesthetic characteristics, durability properties, and its suitability for long term contact with paper), but would have thin strips of “static cling” vinyl on the edges to be used as the main adhesive force that will touch the cylindrical glass bottle. Such strips will typically have a thickness of between 1 to 10 mils or between about 1 and 7 mils or about 2 mils.

Machine-Readable Identifiers

Some embodiments of the label protectors will include machine-readable identifiers such as a standard bar code, a 2-D bar code or a RFID tag. The machine-readable identifiers may be used to manage collections of generally-cylindrical containers such as wine collections. For example, a wine collector can apply a label protector with a unique 2D barcode to each new bottle added to the collection. The 2D barcode on each bottle can be conveniently read with a cell phone with an appropriate application. Such an application can allow entry of the type of wine as well as other information of interest to the collector such as price paid for the wine, date the wine was purchased, place of purchase, date or date range when the wine should be drunk, ratings for the wine, etc. The wine collector can again scan the 2D barcode when the wine is removed from the collection to sell or drink the wine. The database can be updated with the sale price or notes from tasting the wine.

The previous description of the disclosed examples is provided to enable any person of ordinary skill in the art to make or use the disclosed methods and apparatus. Various modifications to these examples will be readily apparent to those skilled in the art, and the principles defined herein may be applied to other examples without departing from the spirit or scope of the disclosed method and apparatus. The described embodiments are to be considered in all respects only as illustrative and not restrictive and the scope of the invention is, therefore, indicated by the appended claims rather than by the foregoing description. All changes which come within the meaning and range of equivalency of the claims are to be embraced within their scope.

1. A label-protected, generally-cylindrical container comprising:
a generally-cylindrical container having a label;
a label protector made of a transparent, flexible plastic sheet and having a left edge, a right edge, and an inner surface, the label protector positioned over the label such that the label is protected from wear but substantially visible through the label protector, and wrapped around the generally-cylindrical container so that the left edge and the right edge of the label protector overlap, the inner surface of the label protector has a zone that limits movement of the label protector with respect to the generally-cylindrical container, and at least a portion of the transparent, flexible plastic sheet in contact with the label is made of a plastic suitable for long term contact with the label; and
an adhesive disposed between the overlapping portion of the left edge and the right edge to affix the left edge to the right edge.

2. The label-protected, generally-cylindrical container of claim 1, wherein the zone is disposed to substantially avoid contact with the label.

3. The label-protected, generally-cylindrical container of claim 1, wherein the zone comprises a static cling plastic, an adhesive, a silicone resin, a silicone plastic or combinations thereof.

4. The label-protected, generally-cylindrical container of claim 1, wherein the zone is disposed substantially along a top edge of the sheet, a bottom edge of the sheet or both.

5. The label-protected, generally-cylindrical container of claim 1, where the zone was formed by application of a deadener to the adherent or adhesive inner surface of the label protector outside of the patch.

6. The label-protected, generally-cylindrical container of claim 5, wherein the deadener is a polyester or cellulose acetate varnish suitable for long term contact with the label.

7. A label-protected, generally-cylindrical container comprising:
a generally-cylindrical container having a paper label; and
a label protector made of a transparent, flexible plastic sheet and having a left edge, a right edge, and an inner surface, the label protector positioned over the label such that the label is protected from wear but substantially visible through the label protector, and partially wrapped around the generally-cylindrical container and adheres to the container through an adhesive or adherent zone disposed on the inner surface of the label protector to substantially avoid adhering to the label, and wherein at least the portion of the transparent, flexible plastic sheet in contact with the label is a plastic suitable for long term contact with paper.

8. A label-protected, generally-cylindrical container comprising:
a generally-cylindrical container comprising a paper label; and
a label protector made of a transparent, flexible plastic sheet and having a left edge, a right edge, and an inner surface, the label protector positioned over the label such that the label is protected from wear but substantially visible through the label protector, and partially wrapped around the generally-cylindrical container and affixed to the container through an adhesive or adherent zone disposed on the inner surface, wherein the adhesive or adherence of the zone is affixed with sufficient force so that the label protector remains in position while not sufficient to damage the label when the label protector is removed, and wherein at least the portion of the transparent, flexible plastic sheet in contact with the label is a plastic suitable for long term contact with paper.

9. The label-protected, generally-cylindrical container of claim 8, wherein the generally-cylindrical container is a wine bottle.

10. The label-protected, generally-cylindrical container of claim 8, wherein the inner surface is cellulose acetate, polyester, polypropylene, or polyethylene.

11. The label-protected, generally-cylindrical container of claim 10, wherein the entire plastic sheet is polyester, polypropylene, and polyethylene.

12. The label-protected, generally-cylindrical container of claim 8, wherein the transparent, flexible plastic sheet is between 1 and 10 mils thick.

13. The label-protected, generally-cylindrical container of claim 8, wherein the transparent, flexible plastic sheet is between 3 and 6 mils thick.

14. The label-protected, generally-cylindrical container of claim 8, wherein the transparent, flexible plastic sheet is between 1 and 3 mils thick.

15. The label-protected, generally-cylindrical container of claim 8, wherein the label protector further comprises a tab to facilitate removal of the label protector.

16. The label-protected, generally-cylindrical container of claim 15, wherein the tab is part of the sheet.

17. The label-protected, generally-cylindrical container of claim 15, wherein the tab is proximal to a perforated zone extending substantially across the label protector to allow removal of the label protector by tearing along the perforated zone.

18. The label-protected, generally-cylindrical container of claim 8, wherein the label protector further comprises one or more flexible plastic tabs disposed along a bottom edge so that the flexible plastic tabs fold under and adhere to the bottom of the container through an adhesive or adherent tab zone on each plastic tab.

19. The label-protected, generally-cylindrical container of claim 8, wherein the label protector further comprises two or more flexible tabs disposed along a bottom edge so that the flexible tabs fold under the bottom of the container and overlap at least a portion of another flexible tab and an adhesive or adherent tab zone is disposed between the overlapping portions to affix the flexible tabs to each other.

20. The label-protected, generally-cylindrical container of claim 8, wherein the label protector further comprises an opaque portion on the outer surface for writing.

21. The label-protected, generally-cylindrical container of claim 8, wherein the label protector further comprises a machine-readable identifier.

22. The label-protected, generally-cylindrical container of claim 9, wherein the wine bottle is a Bordeaux-style bottle, a Burgundy-style bottle, a Champagne-style bottle, hock-style bottle, Bocksbeutel-style bottle, or a fiasco-style bottle.

23. The label-protected, generally-cylindrical container of claim 9, wherein the wine bottle size is selected from a group consisting of: split, chopine, half, Jennie, standard, magnum, Jeroboam, Rehoboam, Methuselah, Salmanazar, Balthazar, Nebuchadnezzar, Melchior, Solomon, Sovereign, Primat, and Melchizedek.

24-58. (canceled)
